(19) United States
(12) Patent Application Publication
(10) Pub. No.: US 2023/0185997 A1
(43) Pub. Date: Jun. 15, 2023

(54) SYSTEM AND METHOD FOR MACHINE-ASSISTED COLLABORATION IN PRODUCT DESIGN

(71) Applicant: TOYOTA RESEARCH INSTITUTE, INC., Los Altos, CA (US)

(72) Inventors: Shabnam HAKIMI, San Francisco, CA (US); Scott CARTER, San Jose, CA (US); Jonathan A. DECASTRO, Arlington, MA (US); Emily S. SUMNER, Berkeley, CA (US); Yue WENG, San Mateo, CA (US); Nikos ARECHIGA, San Mateo, CA (US)

(73) Assignee: TOYOTA RESEARCH INSTITUTE, INC., Los Altos, CA (US)

(21) Appl. No.: 17/550,496

(22) Filed: Dec. 14, 2021

(51) Int. Cl. G06F 30/27; G06N 3/08; G06Q 10/10

(52) U.S. Cl. CPC G06F 30/27; G06N 3/08; G06Q 10/101

(57) ABSTRACT

A method for machine-assisted collaborative product design is described. The method includes training a neural network to simulate a plurality of stakeholder personas in a product review process to provide a plurality of stakeholder models. The method also includes simulating, using the plurality of stakeholder models, the plurality of stakeholder personas in the product review process of a potential product. The method further includes aggregating individual scores output from the plurality of stakeholder models corresponding to each of the plurality of stakeholder personas regarding the potential product; wherein each of the individual scores corresponds to a stakeholder persona and that stakeholder persona's reaction to the potential product. The method also includes displaying a summary providing an overview of the aggregated individual scores regarding the potential product to a user.

### BACKGROUND

### Field

Certain aspects of the present disclosure generally relate to machine learning and, more particularly, to a system and method for a machine-assisted collaboration in product design.

### Background

A conventional product design process involves multiple stakeholders that engage in a product review process to provide a final product. Unfortunately, each of the stakeholders may have different opinions, needs, and metrics for determining a successful product. These differences between stakeholders can cause friction, not only because people may disagree on the best design, but also because each stakeholder may feel slighted if their unique insights are lost in the product design process.

Currently, feedback for new designs is largely ad hoc or provided through standard means of communication, including in-person meetings and email. The structure of this process makes it susceptible to miscommunication, especially because designers typically do not see the full set of stakeholder feedback until the end of the design process. Once the design process is finished it may be too costly or time consuming to return and redesign to accommodate design ideas from stakeholder feedback. Furthermore, stakeholders may prioritize different design improvements based on their position in the design process. For example, when designing a new product, a product designer may propose a new design that prioritizes innovation and aesthetics, while an engineer may prioritize feasibility in manufacturing. A team member in sales may, on the other hand, propose a new design that prioritizes features that have previously sold well or are based on consumer requests.

The collaborative process of selecting and producing a new product, therefore, involves cross-functional understanding and compromise, both skills that can be difficult to cultivate. A system and method that facilitate stakeholder collaboration in the product design process, are desired.

### SUMMARY

A method for machine-assisted collaborative product design is described. The method includes training a neural network to simulate a plurality of stakeholder personas in a product review process to provide a plurality of stakeholder models. The method also includes simulating, using the plurality of stakeholder models, the plurality of stakeholder personas in the product review process of a potential product. The method further includes aggregating individual scores output from the plurality of stakeholder models corresponding to each of the plurality of stakeholder personas regarding the potential product; wherein each of the individual scores corresponds to a stakeholder persona and that stakeholder persona's reaction to the potential product. The method also includes displaying a summary providing an overview of the aggregated individual scores regarding the potential product to a user.

A non-transitory computer-readable medium having program code recorded thereon for machine-assisted collaborative product design is described. The program code is executed by a processor. The non-transitory computer-readable medium includes program code to train a neural network to simulate a plurality of stakeholder personas in a product review process to provide a plurality of stakeholder models. The non-transitory computer-readable medium also includes program code to simulate, using the plurality of stakeholder models, the plurality of stakeholder personas in the product review process of a potential product. The non-transitory computer-readable medium further includes program code to aggregate individual scores output from the plurality of stakeholder models corresponding to each of the plurality of stakeholder personas regarding the potential product; wherein each of the individual scores corresponds to a stakeholder persona and that stakeholder persona's reaction to the potential product. The non-transitory computer-readable medium also includes program code to display a summary providing an overview of the aggregated individual scores regarding the potential product to a user.

A system for machine-assisted collaborative product design is described. The system includes a stakeholder persona training module to training a neural network to simulate a plurality of stakeholder personas in a product review process to provide a plurality of stakeholder models. The system also includes a stakeholder simulation engine to simulating, using the plurality of stakeholder models, the plurality of stakeholder personas in the product review process of a potential product. The system further includes a stakeholder score aggregation engine to aggregate individual scores output from the plurality of stakeholder models corresponding to each of the plurality of stakeholder personas regarding the potential product; wherein each of the individual scores corresponds to a stakeholder persona and that stakeholder persona's reaction to the potential product. The system also includes a feedback report display module to display a summary providing an overview of the aggregated individual scores regarding the potential product to a user.

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC) of a machine-assisted collaborative product design system, in accordance with aspects of the present disclosure.

FIG. 2 is a block diagram illustrating an exemplary software architecture that may modularize artificial intelligence (AI) functions of a machine-assisted collaborative product design system, according to aspects of the present disclosure.

FIG. 3 is a diagram illustrating a hardware implementation of a machine-assisted collaborative product design system, according to aspects of the present disclosure.

FIG. 4 is a block diagram illustrating a machine-assisted collaborative product design process, in accordance with aspects of the present disclosure.

FIG. 5 is a block diagram illustrating a machine-assisted collaborative product design application on a mobile device, in accordance with aspects of the present disclosure.

FIG. 6 is a flowchart illustrating a machine-assisted collaborative product design process, according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure disclosed may be embodied by one or more elements of a claim.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be broadly applicable to different technologies, system configurations, networks, and protocols, some of which are illustrated by way of example in the figures and in the following description of the preferred aspects. The detailed description and drawings are merely illustrative of the present disclosure, rather than limiting the scope of the present disclosure being defined by the appended claims and equivalents thereof.

As noted, a conventional product design process involves multiple stakeholders that engage in a product review process to provide a final product. Unfortunately, each of the stakeholders may have different opinions, needs, and metrics for determining a successful product. These differences between stakeholders can cause friction, not only because people may disagree on the best design, but also because each stakeholder may feel slighted if their unique insights are lost in the product design process.

Currently, feedback for new designs is largely ad hoc or provided through standard means of communication, including in-person meetings and email. The structure of this process makes it susceptible to miscommunication, especially because designers typically do not see the full set of stakeholder feedback until the end of the design process. Once the design process is finished it may be too costly or time consuming to return and redesign to accommodate design ideas from stakeholder feedback. Furthermore, stakeholders may prioritize different design improvements based on their position in the design process. For example, when designing a new product, a product designer may propose a new design that prioritizes innovation and aesthetics, while an engineer may prioritize feasibility in manufacturing. A team member in sales may, on the other hand, propose a new design that prioritizes features that have previously sold well or are based on consumer requests.

The collaborative process of selecting and producing a new product, therefore, involves cross-functional understanding and compromise, both skills that can be difficult to cultivate. A system and method that facilitate stakeholder collaboration in the product design process, are desired. Some aspects of the present disclosure facilitate stakeholder collaboration in the product design process. These aspects of the present disclosure use detailed personas to simulate each stakeholder and their feedback on potential designs, allowing the user to anticipate and better understand the needs of their collaborators.

Some aspects of the present disclosure leverage both machine learning and behavioral science to generate dynamic models of individual decision makers in a product design process. These aspects of the present disclosure supply personas to simulate the perspective of other stakeholders. Through the feedback of these simulated personas, each stakeholder is able to understand how their colleagues perceive potential product features both as individuals and in relation to others. This solution, therefore, enhances understanding before miscommunication occurs, thereby increasing both collegiality and productivity in collaboration. In some aspects of the present disclosure, a machine-assisted collaborative product design system includes the following components: (1) a configurable model of stakeholder personas, (2) a user interface for model training, (3) a dynamic stakeholder simulation engine, and (4) a configurable interface for reporting feedback.

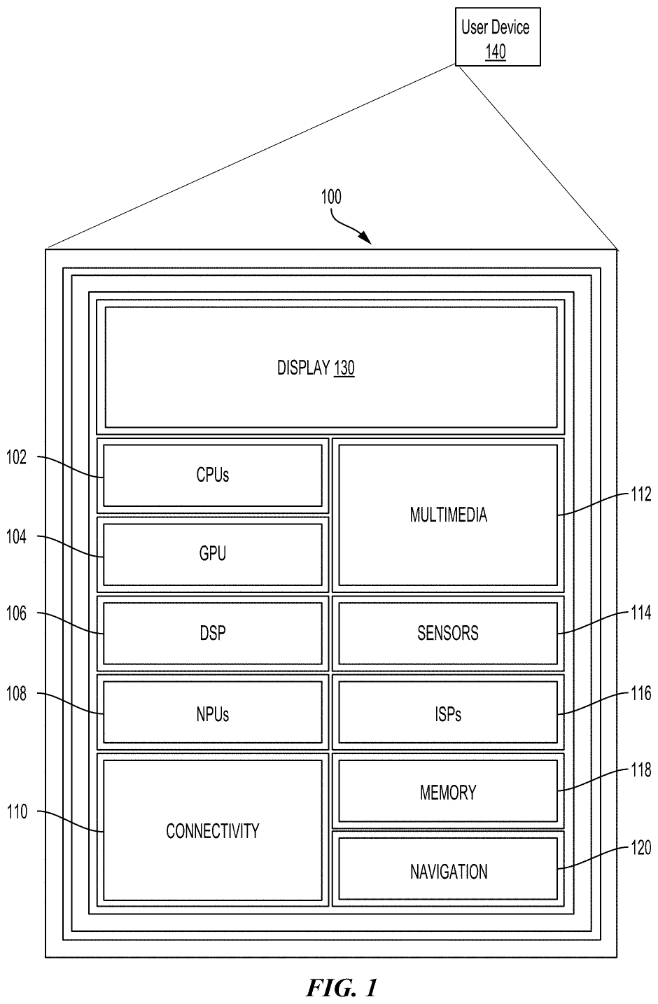

FIG. 1 illustrates an example implementation of the aforementioned system and method for a machine-assisted collaborative product design system using a system-on-a-chip (SOC) 100, according to aspects of the present disclosure. The SOC 100 may include a single processor or multi-core processors (e.g., a central processing unit (CPU) 102), in accordance with certain aspects of the present disclosure. Variables (e.g., neural signals and synaptic weights), system parameters associated with a computational device (e.g., neural network with weights), delays, frequency bin information, and task information may be stored in a memory block. The memory block may be associated with a neural processing unit (NPU) 108, a CPU 102, a graphics processing unit (GPU) 104, a digital signal processor (DSP) 106, a dedicated memory block 118, or may be distributed across multiple blocks. Instructions executed at a processor (e.g., CPU 102) may be loaded from a program memory associated with the CPU 102 or may be loaded from the dedicated memory block 118.

The SOC 100 may also include additional processing blocks configured to perform specific functions, such as the GPU 104, the DSP 106, and a connectivity block 110, which may include fourth generation long term evolution (4G LTE) connectivity, unlicensed Wi-Fi connectivity, USB connectivity, Bluetooth® connectivity, and the like. In addition, a multimedia processor 112 in combination with a display 130 may, for example, select a control action, according to the display 130 illustrating a view of a user device.

In some aspects, the NPU 108 may be implemented in the CPU 102, DSP 106, and/or GPU 104. The SOC 100 may further include a sensor processor 114, image signal processors (ISPs) 116, and/or navigation 120, which may, for instance, include a global positioning system. The SOC 100 may be based on an Advanced Risk Machine (ARM) instruction set or the like. In another aspect of the present disclosure, the SOC 100 may be a server computer in communication with a user device 140. In this arrangement, the user device 140 may include a processor and other features of the SOC 100.

In this aspect of the present disclosure, instructions loaded into a processor (e.g., CPU 102) or the NPU 108 of the user device 140 may include code to enable a machine-assisted collaborative product design process. The instructions loaded into the CPU 102 may also include code to train a neural network to simulate a plurality of stakeholder personas in a product review process to provide a plurality of stakeholder models. The instructions loaded into the CPU 102 may also include code to simulate, using the plurality of stakeholder models, the plurality of stakeholder personas in the product review process of a potential product. The instructions loaded into the CPU 102 may also include code to aggregate individual scores from the plurality of stakeholder models corresponding to each of the plurality of stakeholder personas regarding the potential product. In some aspects of the present disclosure, each of the individual scores corresponds to a stakeholder persona and that stakeholder persona's reaction to the potential product. The instructions loaded into the CPU 102 may also include code to display a summary providing an overview of the aggregated individual scores regarding the potential product to a user.

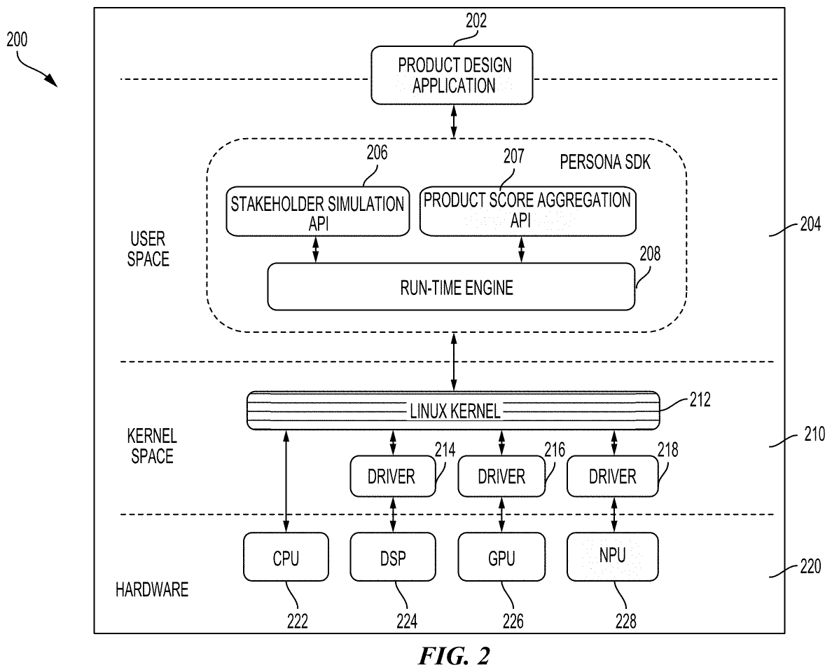

FIG. 2 is a block diagram illustrating a software architecture 200 that may modularize artificial intelligence (AI) functions for a machine-assisted collaborative product design system, according to aspects of the present disclosure. Using the architecture, a product design application 202 may be designed such that it may cause various processing blocks of a system-on-a-chip (SOC) 220 (for example a CPU 222, a DSP 224, a GPU 226, and/or an NPU 228) to perform supporting computations during run-time operation of the product design application 202. FIG. 2 describes the software architecture 200 for the machine-assisted collaborative product design system. It should be recognized that the machine-assisted collaborative product design system is not limited to product design. According to aspects of the present disclosure, the machine-assisted collaborative product design functionality is applicable to any type of user activity between different individuals, such as the young and the older generations.

The product design application 202 may be configured to call functions defined in a user space 204 that may, for example, provide for machine-assisted collaborative product design of a potential product. The product design application 202 may make a request for compiled program code associated with a library defined in a stakeholder simulation application programming interface (API) 206. The stakeholder simulation API 206 is configured to simulate, using a plurality of stakeholder models, a plurality of stakeholder personas in a product review process. In response, the compiled program code of a product score aggregation API 207 is configured to aggregate individual scores from the plurality of stakeholder models corresponding to each of the plurality of stakeholder personas regarding the potential product. In some aspects of the present disclosure, each of the individual scores corresponds to a stakeholder persona and that stakeholder persona's reaction to the potential product.

A run-time engine 208, which may be compiled code of a run-time framework, may be further accessible to the product design application 202. The product design application 202 may cause the run-time engine 208, for example, to generate a summary providing an overview of the aggregated individual scores regarding the potential product to a user. In response to the summary of the aggregated individual scores, the run-time engine 208 may in turn send a signal to an operating system 210, such as a Linux Kernel 212, running on the SOC 220. FIG. 2 illustrates the Linux Kernel 212 as software architecture for machine-assisted collaborative product design of a potential product. It should be recognized, however, that aspects of the present disclosure are not limited to this exemplary software architecture. For example, other kernels may provide the software architecture to support the behavioral empathy and understanding functionality.

The operating system 210, in turn, may cause a computation to be performed on the CPU 222, the DSP 224, the GPU 226, the NPU 228, or some combination thereof. The CPU 222 may be accessed directly by the operating system 210, and other processing blocks may be accessed through a driver, such as drivers 214-218 for the DSP 224, for the GPU 226, or for the NPU 228. In the illustrated example, the deep neural network may be configured to run on a combination of processing blocks, such as the CPU 222 and the GPU 226, or may be run on the NPU 228, if present.

Currently, feedback for new designs is largely ad hoc or provided through standard means of communication, including in-person meetings and email. The structure of this process makes it susceptible to miscommunication, especially because designers typically do not see the full set of stakeholder feedback until the end of the design process. Once the design process is finished it may be too costly or time consuming to return and redesign to accommodate design ideas from stakeholder feedback. Furthermore, stakeholders may prioritize different design improvements based on their position in the design process. For example, when designing a new product, a product designer may propose a new design that prioritizes innovation and aesthetics, while an engineer may prioritize feasibility in manufacturing. A team member in sales may, on the other hand, propose a new design that prioritizes features that have previously sold well or are based on consumer requests.

Some aspects of the present disclosure leverage both machine learning and behavioral science to generate dynamic models of individual decision makers in a product design process. These aspects of the present disclosure use detailed personas to simulate each stakeholder and their feedback on potential designs, allowing the user to anticipate and better understand the needs of their collaborators. That is, these aspects of the present disclosure supply personas to simulate the perspective of other stakeholders. Through the feedback of these simulated personas, each stakeholder is able to understand how their colleagues perceive potential product features both as individuals and in relation to others. This solution, therefore, enhances understanding before miscommunication occurs, thereby increasing both collegiality and productivity in a collaborative product design process.

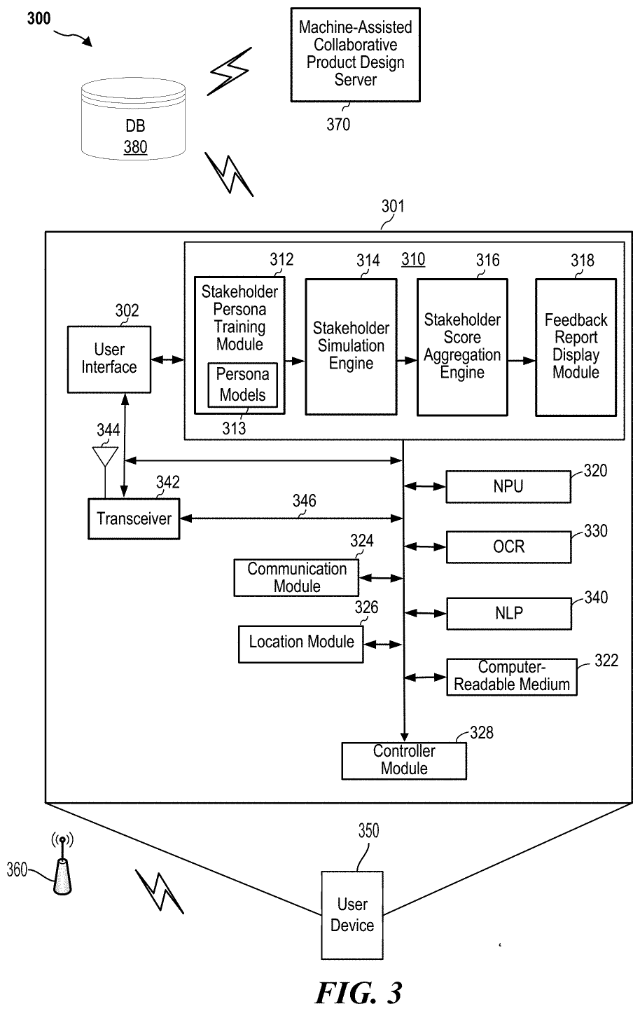

FIG. 3 is a diagram illustrating a hardware implementation for a machine-assisted collaborative product design system 300, according to aspects of the present disclosure. The machine-assisted collaborative product design system 300 may be configured to enable a machine-assisted collaborative product design process. The machine-assisted collaborative product design system 300 is also configured to train a neural network to simulate a plurality of stakeholder personas in a product review process to provide a plurality of stakeholder models. In addition, the machine-assisted collaborative product design system 300 is configured to simulate, using the plurality of stakeholder models, the plurality of stakeholder personas in the product review process of a potential product.

In response, the machine-assisted collaborative product design system 300 is also configured to aggregate individual scores from the plurality of stakeholder models corresponding to each of the plurality of stakeholder personas regarding the potential product. In some aspects of the present disclosure, each of the individual scores corresponds to a stakeholder persona and that stakeholder persona's reaction to the potential product. The machine-assisted collaborative product design system 300 is also configured to display a summary providing an overview of the aggregated individual scores regarding the potential product to a user.

The machine-assisted collaborative product design system 300 includes a product design system 301 and a machine-assisted collaborative product design server 370 in this aspect of the present disclosure. The product design system 301 may be a component of a user device 350. The user device 350 may be a cellular phone (e.g., a smart phone), a personal digital assistant (PDA), a wireless modem, a wireless communications device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a global positioning system device, or any other suitable device that is configured to communicate via a wireless or wired medium.

The machine-assisted collaborative product design server 370 may connect to the user device 350 for enabling a machine-assisted, collaborative product design process. For example, the machine-assisted collaborative product design server 370 may train a neural network to simulate a plurality of stakeholder personas in a product review process to provide a plurality of stakeholder models. In response, the machine-assisted collaborative product design server 370 is configured to simulate, using the plurality of stakeholder models, the plurality of stakeholder personas in the product review process of a potential product.

In addition, the machine-assisted collaborative product design server 370 is configured to aggregate individual scores from a plurality of stakeholder models corresponding to each of the plurality of stakeholder personas regarding the potential product. In some aspects of the present disclosure, each of the individual scores corresponds to a stakeholder persona and that stakeholder persona's reaction to the potential product. The machine-assisted collaborative product design server 370 is also configured to display a summary providing an overview of the aggregated individual scores regarding the potential product to a user.

The product design system 301 may be implemented with an interconnected architecture, represented generally by an interconnect 346. The interconnect 346 may include any number of point-to-point interconnects, buses, and/or bridges depending on the specific application of the product design system 301 and the overall design constraints. The interconnect 346 links together various circuits including one or more processors and/or hardware modules, represented by a user interface 302, a product design module 310, a neutral network processor (NPU) 320, a computer-readable medium 322, a communication module 324, a location module 326, an optical character recognition (OCR) 330, a natural language processor (NLP) 340, and a controller module 328. The interconnect 346 may also link various other circuits such as timing sources, peripherals, voltage regulators, and power management circuits, which are well known in the art, and therefore, will not be described any further.

The product design system 301 includes a transceiver 342 coupled to the user interface 302, the product design module 310, the NPU 320, the computer-readable medium 322, the communication module 324, the location module 326, the OCR 330, the NLP 340, and the controller module 328. The transceiver 342 is coupled to an antenna 344. The transceiver 342 communicates with various other devices over a transmission medium. For example, the transceiver 342 may receive commands via transmissions from a user. In this example, the transceiver 342 may receive/transmit information for the product design module 310 to/from connected devices within the vicinity of the user device 350.

The product design system 301 includes the NPU 320 coupled to the computer-readable medium 322. The NPU 320 performs processing, including the execution of software stored on the computer-readable medium 322 to provide a neural network model for machine-assisted, collaborative product design functionality according to the present disclosure. The software, when executed by the NPU 320, causes the product design system 301 to perform the various functions described for presenting scores provided by simulated stakeholders to the user through the user device 350, or any of the modules (e.g., 310, 324, 326, 330, and/or 340). The computer-readable medium 322 may also be used for storing data that is manipulated by the NPU 320 when executing the software to analyze user communications.

The location module 326 may determine a location of the user device 350. For example, the location module 326 may use a global positioning system (GPS) to determine the location of the user device 350. The location module 326 may implement a dedicated short-range communication (DSRC)-compliant GPS unit. A DSRC-compliant GPS unit includes hardware and software to make the autonomous vehicle 350 and/or the location module 326 compliant with the following DSRC standards, including any derivative or fork thereof: EN 12253:2004 Dedicated Short-Range Communication—Physical layer using microwave at 5.8 GHz (review); EN 12795:2002 Dedicated Short-Range Communication (DSRC)—DSRC Data link layer: Medium Access and Logical Link Control (review); EN 12834:2002 Dedicated Short-Range Communication—Application layer (review); EN 13372:2004 Dedicated Short-Range Communication (DSRC)—DSRC profiles for RTTT applications (review); and EN ISO 14906:2004 Electronic Fee Collection—Application interface.

The communication module 324 may facilitate communications via the transceiver 342. For example, the communication module 324 may be configured to provide communication capabilities via different wireless protocols, such as 5G new radio (NR), Wi-Fi, long term evolution (LTE), 4G, 3G, etc. The communication module 324 may also communicate with other components of the user device 350 that are not modules of the product design system 301. The transceiver 342 may be a communications channel through a network access point 360. The communications channel may include DSRC, LTE, LTE-D2D, mmWave, Wi-Fi (infrastructure mode), Wi-Fi (ad-hoc mode), visible light communication, TV white space communication, satellite communication, full-duplex wireless communications, or any other wireless communications protocol such as those mentioned herein.

The product design system 301 also includes the NPU 320 to simulate a plurality of stakeholder personas in a product review process to provide a plurality of stakeholder models. From behavioral science, it is recognized that differences between stakeholders during a design process can cause friction, not only because people may disagree on the best design, but also because each stakeholder may feel slighted if their unique insights are lost in the product design process. As a result, the product design system 301 may simulate stakeholders in a product design process, using the NPU 320. In these aspects of the present disclosure, the product design module 310, in conjunction with the NPU 320, aggregate individual scores from a plurality of stakeholder models corresponding to each of the plurality of stakeholder personas regarding the potential product. These aspects of the present disclosure use detailed personas to simulate each stakeholder and their feedback on potential designs, allowing the user to anticipate and better understand the needs of their collaborators.

The product design module 310 may be in communication with the user interface 302, the NPU 320, the computer-readable medium 322, the communication module 324, the location module 326, the OCR 330, the NLP 340, the controller module 328, and the transceiver 342. In one configuration, the product design module 310 monitors communications from the user interface 302. The product design module 310 may monitor user communications to and from the communication module 324. According to aspects of the present disclosure, the NPU 320 enables training of a neural network to simulate a plurality of stakeholder personas in a product review process to provide a plurality of stakeholder models.

As shown in FIG. 3, the product design module 310 includes a stakeholder persona training module 312, persona models 313, a stakeholder simulation engine 314, a stakeholder score aggregation engine 316, and a feedback report display module 318. The stakeholder persona training module 312, the persona models 313, the stakeholder simulation engine 314, the stakeholder score aggregation engine 316, and the feedback report display module 318 may be components of a same or different artificial neural network. In some aspects of the present disclosure, the persona models 313 may be implemented using a convolutional neural network (CNN), such as a deep learning CNN.

This configuration of the product design module 310 includes the stakeholder persona training module 312 configured to train a neural network to simulate a plurality of stakeholder personas in a product review process to provide a plurality of stakeholder models, such as the persona models 313. In addition, the product design module 310 includes the stakeholder simulation engine 314 configured to simulate, using the plurality of stakeholder models, the plurality of stakeholder personas in the product review process of a potential product. In addition, the product design module 310 includes the stakeholder score aggregation engine 316 configured to aggregate individual scores from the plurality of stakeholder models corresponding to each of the plurality of stakeholder personas regarding the potential product.

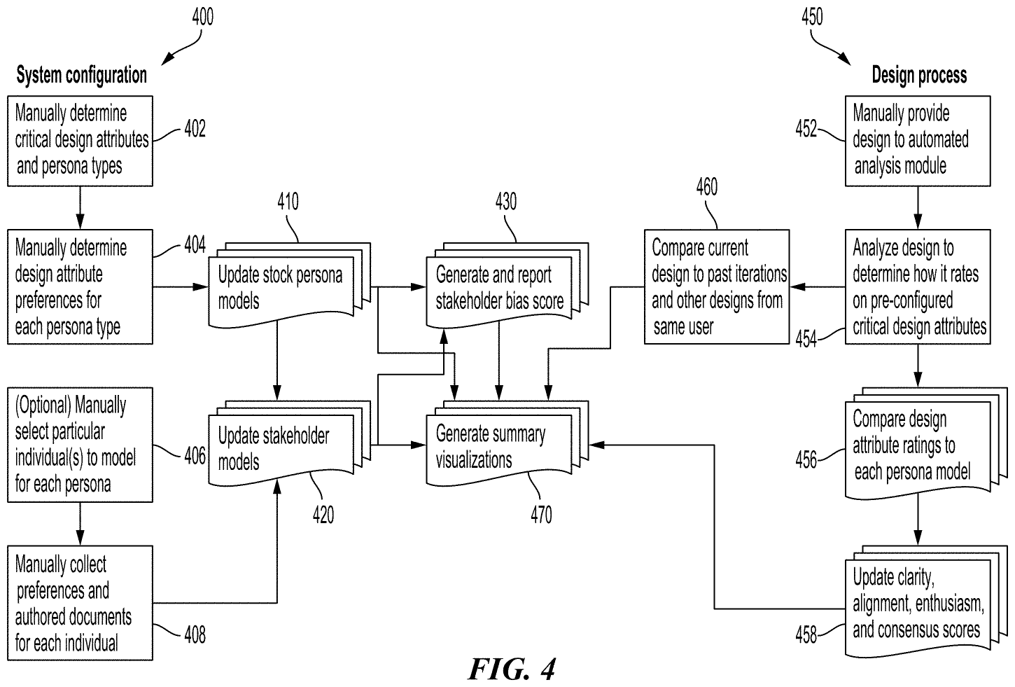

In some aspects of the present disclosure, each of the individual scores corresponds to a stakeholder persona and that stakeholder persona's reaction to the potential product. The product design module 310 also includes the feedback report display module 318 configured to display a summary providing an overview of the aggregated individual scores regarding the potential product to a user. In some aspects of the present disclosure, the product design module 310 may be implemented and/or work in conjunction with the machine-assisted collaborative product design server 370 to perform a collaborative design process, for example, as shown in FIG. 4.

FIG. 4 is a block diagram illustrating a machine-assisted collaborative product design process including a system configuration process, in accordance with aspects of the present disclosure. A system configuration process 400 begins at block 402, in which critical design attributes and persona types are manually determined. For example, these persona types may include a computer aided design (CAD) designer persona, a manager persona, a product lead person, and other like product design personas. At block 404, design attribute preferences for each persona type are manually determined. At block 410, stock persona models are updated according to the manually determined design attribute preferences for each persona type of block 404.

Optionally, at block 406, particular individuals are manually selected to model for each persona. At block 408, preferences and authored documents for each individual selected in block 406 are manually collected. At block 420, stakeholder models are updated. The system configuration process 400 may also include generating of reporting of a stakeholder bias score at block 430.

Updating of the stakeholder models at block 420 may be based on the manually collected preferences and authored documents at block 408 for each individual selected in block 406. In addition, updating of the stakeholder models at block 420 may be based on updating of the stock persona models at block 410. In these aspects of the present disclosure, the user configures each stakeholder, providing details about the identity and known preferences of the individuals being simulated. In addition to specific traits being configured, the persona models 313 of FIG. 3 accept biographical information and information from patent databases. The user may also input past feedback from the stakeholders for the user's own designs or those of others.

In some aspects of the present disclosure, updating of the stakeholder models at block 420 may be performed by the stakeholder persona training module 312, including the persona models 313. In some aspects of the present disclosure, the persona models 313 provide a configurable model of stakeholder personas based on extensive ethnographic and behavioral science research and contain representations of multiple stakeholders typically involved in the product design process. For example, each persona has attributes with ranked preferences across multiple dimensions, including novelty and potential sales. These dimensions may be determined using the responses to structured questions and through data-driven analysis of interview responses. In addition, these responses may be aggregated across roles to link preferences to each persona.

A product design process 450 of FIG. 4 begins at block 452, in which a product design is manually provided to an automated analysis module. For example, a written description of the potential product is provided as an input to the stakeholder simulation engine 314 of FIG. 3. In some aspects of the present disclosure, the stakeholder simulation engine 314 takes a description of the design (text, image, or speech) as input. Using a machine learning algorithm, the simulation engine generates a series of scores from each persona for the design description. In some aspects of the present disclosure, the stakeholder simulation engine 314 also maintains representations of previous interactions with the user. These previous interactions may be iterative updates to the current design or may reflect past designs. In some aspects of the present disclosure, the stakeholder simulation engine 314 also learns about how the user responds to stakeholder feedback from these interactions and may tailor the framing of the feedback depending on the user's response to previous feedback.

At block 454 of the product design process 450 of FIG. 4, the product design is analyzed to determine how the product design rates based on pre-configured design attributes. For example, at block 460, the current design is compared to past iterations of the design as well as other designs from the same user. At block 456, the product design attribute ratings are compared to each persona model. At block 458, products scores are updated. At block 470, a summary of visualizations is generated.

For example, for each stakeholder persona of the persona models 313, the user interface 302 reports several metrics, each with a value between 1 and 5 for the product design attribute ratings of block 458. In this example, product design attribute ratings include a clarity score based on the clarity of the product description. In particular, how understandable is the product design without additional information? The product design attribute ratings may also include an alignment score, based on the extent of alignment between the design and the specifications of the stakeholder personas. The product design attribute ratings further include an enthusiasm score based on a level of excitement the persona has for the design. When the stakeholder persona has been configured, the user interface 302 also provides a bias score that reflects the difference between the stock persona and the one customized by the user. This metric allows the user to assess how much bias they have introduced into the process so that they can take that into account when interpreting the feedback at block 470.

In addition to the product design attribute rating scores, the user interface also reports a consensus score that reflects the extent to which there is agreement across the stakeholder personas. The user interface 302 reports aggregated scores (e.g., averaged across stakeholders) and a summary of feedback to the user using the feedback report display module 318. For example, this summary provides an overview of the feedback from all stakeholders. The user can choose which stakeholders to receive feedback from and the style of their feedback. In this example, the user can choose the order in which positive and negative feedback is reported. In addition analytical tools, such as game theory, are used to simulate the decision-making process.

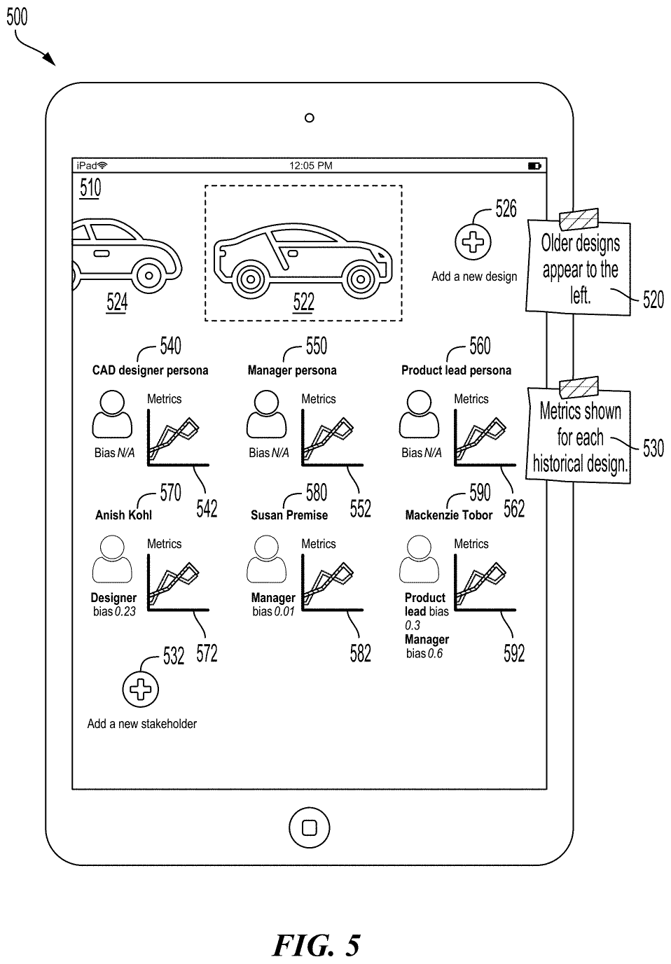

FIG. 5 is a block diagram illustrating a machine-assisted collaborative product design application on a mobile device, in accordance with aspects of the present disclosure. In some aspects of the present disclosure, a mobile device 500 runs a machine-assisted collaborative product design mobile application 510. In this aspect of the present disclosure, the machine-assisted collaborative product design mobile application 510 includes a previous designs section 520, which illustrates previous vehicle designs 522 and 524, as well as an icon 526 to add a new design.

The machine-assisted collaborative product design mobile application 510 also includes a metrics section 530 for each historical design. For example, a computer aided design (CAD) designer persona 540 is shown including a metrics graph 542, in which there is no corresponding bias score. In addition, a manager persona 550 is shown, including a metrics graph 552. A product lead persona 560 is also shown, including a metrics graph 562. As noted, the various personas in this example do not include an associated bias, as these simulated personas are presumed to operate without a bias.

The metrics section 530 of the machine-assisted collaborative product design mobile application 510 further illustrates a designer 570 (e.g., Anish Kohl) having a metrics graph 572 and a designer bias value of 0.23 relative to the CAD designer persona 540. In addition, a manager 580 (e.g., Susan Premise) is shown, having a metrics graph 582 and a manager bias value of 0.01 relative to the manager persona 550. A product lead/manager 590 (e.g., Mackenzie Tobor) is shown, having a metrics graph 592, a product lead bias value of 0.3 relative to the product lead persona 560, and a manager bias value of 0.6 relative to the manager persona 550. In addition, an icon 532 is shown for adding a new stakeholder.

In some aspects of the present disclosure, each of the metrics graphs (e.g., 542, 552, 562, 572, 582, and 592) is a multiple line graph with the design version on the X-axis. These metrics graphs may include three line plots showing how a persona's clarity, alignment, and enthusiasm scores have changed for each successive design version.

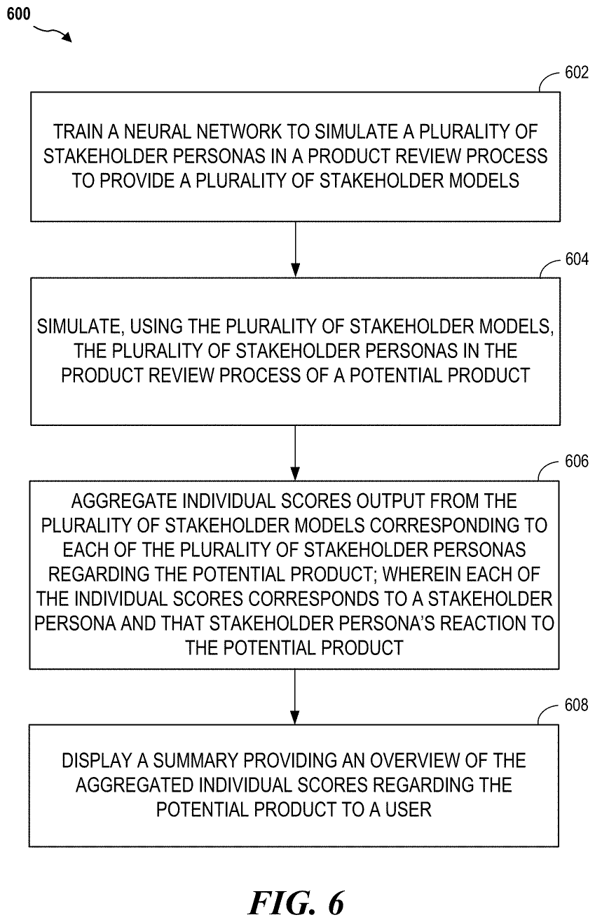

The machine-assisted collaborative product design mobile application 510 may engage in a machine-assisted collaborative product design process, for example, as shown in FIG. 6.

FIG. 6 is a flowchart illustrating a method for machine-assisted collaborative product design, according to aspects of the present disclosure. A method 600 of FIG. 6 begins at block 602, in which a neural network is trained to simulate a plurality of stakeholder personas in a product review process to provide a plurality of stakeholder models. For example, according to the configuration of the product design module 310 shown in FIG. 3, the stakeholder persona training module 312 is configured to train a neural network to simulate a plurality of stakeholder personas in a product review process to provide a plurality of stakeholder models, such as the persona models 313. As shown in FIG. 4, updating of the stakeholder models at block 420 may be performed by the stakeholder persona training module 312 using the persona models 313. The persona models 313 may provide a configurable model of stakeholder personas based on extensive ethnographic and behavioral science research and contain representations of multiple stakeholders typically involved in the product design process. Each persona has attributes with ranked preferences across multiple dimensions, including novelty and potential sales. These dimensions may be determined using the responses to structured questions and through data-driven analysis of interview responses and aggregated across roles to link preferences to each persona.

Referring again to FIG. 6, at block 604, the plurality of stakeholder personas are simulated, using the plurality of stakeholder models, in the product review process of a potential product. For example, as shown in FIG. 3, product design module 310 includes the stakeholder simulation engine 314 configured to simulate, using the plurality of stakeholder models, the plurality of stakeholder personas in the product review process of a potential product. For example, the stakeholder simulation engine 314 takes a description of the design (text, image, or speech) as input. Using a machine learning algorithm, the stakeholder simulation engine 314 generates a series of scores from each persona for the design description. The stakeholder simulation engine 314 may also maintain representations of previous interactions with the user, as shown in FIG. 5. These previous interactions may be iterative updates to the current design or may reflect past designs. the stakeholder simulation engine 314 may also learn about how the user responds to stakeholder feedback from these interactions and may tailor the framing of the feedback depending on the user's response to previous feedback.

At block 606, individual scores output from the plurality of stakeholder models corresponding to each of the plurality of stakeholder personas regarding the potential product are aggregated. In this example, each of the individual scores corresponds to a stakeholder persona and that stakeholder persona's reaction to the potential product. For example, as shown in FIG. 3, the stakeholder score aggregation engine 316 is configured for aggregating individual scores output from the plurality of stakeholder models corresponding to each of the plurality of stakeholder personas regarding the potential product.

At block 608, a summary is displayed providing an overview of the aggregated individual scores regarding the potential product to a user. For example, as shown in FIG. 3, the stakeholder score aggregation engine 316 is configured to aggregate individual scores from the plurality of stakeholder models corresponding to each of the plurality of stakeholder personas regarding the potential product. For example, for each stakeholder persona of the persona models 313, the user interface 302 reports several metrics, each with a value between 1 and 5 for the product design attribute ratings of block 458. In this example, product design attribute ratings include a clarity score, an alignment score, and an enthusiasm score. As shown in FIGURE, 5, when the stakeholder persona has been configured, the user interface 302 also provides a bias score that reflects the difference between the stock persona and the one customized by the user. This metric allows the user to assess how much bias they have introduced into the process so that they can take that into account when interpreting the feedback at block 470.

The method 600 may also include characterizing the user across a set of demographic dimensions. The method 600 may further include identifying a profile of another person with whom the user wants to build greater shared understanding. The method 600 may also include receiving, by a discriminator neural network, the user interactions and the responses of the generator neural network to determine whether actions of the generator neural network are realistic. The method 600 may further include providing, by the discriminator neural network, feedback to the generator neural network based on the determination. The method 600 further includes calculating a clarity score, an alignment score, and/or an enthusiasm score for each stakeholder persona model.

Aspects of the present disclosure leverage both machine learning and behavioral science to generate dynamic models of individual decision makers in a product design process. These aspects of the present disclosure use detailed personas to simulate each stakeholder and their feedback on potential designs, allowing the user to anticipate and better understand the needs of their collaborators. That is, these aspects of the present disclosure supply personas to simulate the perspective of other stakeholders. Through the feedback of these simulated personas, each stakeholder is able to understand how their colleagues perceive potential product features both as individuals and in relation to others. This solution, therefore, enhances understanding before miscommunication occurs, thereby increasing both collegiality and productivity in a collaborative product design process.

The various operations of methods described above may be performed by any suitable means capable of performing the corresponding functions. The means may include various hardware and/or software component(s) and/or module(s), including, but not limited to, a circuit, an application-specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining, and the like. Additionally, “determining” may include receiving (e.g., receiving information), accessing (e.g., accessing data in a memory), and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a processor configured according to the present disclosure, a digital signal processor (DSP), an ASIC, a field-programmable gate array signal (FPGA) or other programmable logic device (PLD), discrete gate or transistor logic, discrete hardware components, or any combination thereof designed to perform the functions described herein. The processor may be a microprocessor, but, in the alternative, the processor may be any commercially available processor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read-only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may connect a network adapter, among other things, to the processing system via the bus. The network adapter may implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Examples of processors that may be specially configured according to the present disclosure include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM, flash memory, ROM, programmable read-only memory (PROM), EPROM, EEPROM, registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in various ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an ASIC with the processor, the bus interface, the user interface, supporting circuitry, and at least a portion of the machine-readable media integrated into a single chip, or with one or more FPGAs, PLDs, controllers, state machines, gated logic, discrete hardware components, or any other suitable circuitry, or any combination of circuits that can perform the various functions described throughout this present disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a non-transitory computer-readable medium. Computer-readable media include both computer storage media and communication media, including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects, computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for machine-assisted collaborative product design, comprising:
training a neural network to simulate a plurality of stakeholder personas in a product review process to provide a plurality of stakeholder models;
simulating, using the plurality of stakeholder models, the plurality of stakeholder personas in the product review process of a potential product;
aggregating individual scores output from the plurality of stakeholder models corresponding to each of the plurality of stakeholder personas regarding the potential product; wherein each of the individual scores corresponds to a stakeholder persona and that stakeholder persona's reaction to the potential product; and
displaying a summary providing an overview of the aggregated individual scores regarding the potential product to a user.

2. The method of claim 1, in which simulating comprises providing a written description of the potential product as an input to the plurality of stakeholder models.

3. The method of claim 1, in which attributes of the individual scores comprise a clarity score, an alignment score, and an enthusiasm score.

4. The method of claim 1, further comprising modifying a design of the potential product according to the summary.

5. The method of claim 1, further comprising modifying, over time, the plurality of stakeholder models corresponding to the plurality of stakeholder personas.

6. The method of claim 1, further comprising:
calculating a clarity score, an alignment score, and/or an enthusiasm score for each stakeholder persona model.

7. The method of claim 1, in which training the neural network comprises:
training the neural network to simulate a stakeholder persona in the product review process to provide a stakeholder persona model; and
repeating the training of the neural network for a plurality of different stakeholder personas to provide the plurality of stakeholder models.

8. The method of claim 1, in which training the neural network comprises:
receiving a bias score; and
training the neural network relative to the bias score.

9. A non-transitory computer-readable medium having program code recorded thereon for machine-assisted collaborative product design, the program code being executed by a processor and comprising:
program code to train a neural network to simulate a plurality of stakeholder personas in a product review process to provide a plurality of stakeholder models;
program code to simulate, using the plurality of stakeholder models, the plurality of stakeholder personas in the product review process of a potential product;
program code to aggregate individual scores output from the plurality of stakeholder models corresponding to each of the plurality of stakeholder personas regarding the potential product; wherein each of the individual scores corresponds to a stakeholder persona and that stakeholder persona's reaction to the potential product; and
program code to display a summary providing an overview of the aggregated individual scores regarding the potential product to a user.

10. The non-transitory computer-readable medium of claim 9, in which the program code to simulate comprises program code to provide a written description of the potential product as an input to the plurality of stakeholder models.

11. The non-transitory computer-readable medium of claim 9, in which attributes of the individual scores comprise a clarity score, an alignment score, and an enthusiasm score.

12. The non-transitory computer-readable medium of claim 9, further comprising program code to modify a design of the potential product according to the summary.

13. The non-transitory computer-readable medium of claim 9, further comprising program code to modify, over time, the plurality of stakeholder models corresponding to the plurality of stakeholder personas.

14. The non-transitory computer-readable medium of claim 9, further comprising:
program code to calculate a clarity score, an alignment score, and/or an enthusiasm score for each stakeholder persona model.

15. The non-transitory computer-readable medium of claim 9, in which the program code to train the neural network comprises:
program code to train the neural network to simulate a stakeholder persona in the product review process to provide a stakeholder persona model; and
program code to repeat the program code to train of the neural network for a plurality of different stakeholder personas to provide the plurality of stakeholder models.

16. The non-transitory computer-readable medium of claim 9, in which the program code to train the neural network comprises:
program code to receive a bias score; and
program code to train the neural network relative to the bias score.

17. A system for machine-assisted collaborative product design, the system comprising:
a stakeholder persona training module to training a neural network to simulate a plurality of stakeholder personas in a product review process to provide a plurality of stakeholder models;
a stakeholder simulation engine to simulating, using the plurality of stakeholder models, the plurality of stakeholder personas in the product review process of a potential product;
a stakeholder score aggregation engine to aggregate individual scores output from the plurality of stakeholder models corresponding to each of the plurality of stakeholder personas regarding the potential product; wherein each of the individual scores corresponds to a stakeholder persona and that stakeholder persona's reaction to the potential product; and
a feedback report display module to display a summary providing an overview of the aggregated individual scores regarding the potential product to a user.

18. The system of claim 17, in which in which the stakeholder persona training module is further to modify, over time, the plurality of stakeholder models corresponding to the plurality of stakeholder personas.

19. The system of claim 17, in which in which the stakeholder score aggregation engine is further to calculate a clarity score, an alignment score, and/or an enthusiasm score for each stakeholder persona model.

20. The system of claim 17, in which in which the stakeholder persona training module is further to train the neural network to simulate a stakeholder persona in the product review process to provide a stakeholder persona model, and program code to repeat the program code to train of the neural network for a plurality of different stakeholder personas to provide the plurality of stakeholder models.
